(19) United States
(12) Patent Application Publication
(10) Pub. No.: US 2011/0185082 A1
(43) Pub. Date: Jul. 28, 2011

(54) SYSTEMS AND METHODS FOR NETWORK VIRTUALIZATION

(75) Inventor: J. Barry Thompson, Easton, PA (US)

(73) Assignee: Tervela, Inc.

(21) Appl. No.: 12/980,444

(22) Filed: Dec. 29, 2010

Related U.S. Application Data
(60) Provisional application No. 61/290,828, filed on Dec. 29, 2009.

(51) Int. Cl. G06F 15/173

(52) U.S. Cl. 709/238; 709/245

(57) ABSTRACT

In a system for network virtualization in a publish and subscribe middleware architecture, a virtual application executes within an execution module on a computer system, where the virtual application has a virtual address and the computer system has a logical address. A network virtualization module manages message routing for the virtual application and a data forwarding plane performs message routing for the virtual application. A communication interface identifies a correspondence between the virtual address and the logical address during message routing with the data forwarding plane and the virtual application.

### BACKGROUND

An Internet Protocol (IP) address is an identifier or logical address assigned to devices and computer systems utilizing the Internet Protocol within a network. IP addresses specify the locations of the source and destination computer systems or nodes in a network topology of a routing system. “Convention virtualization” is a term used to describe associating an IP address with an application such that the application may be moved to a computer system with an IP address that differs from the application, and the application may keep the IP address initially associated with the application for sending and receiving messages over the network. Convention virtualization provides the ability to route to the particular application executing on any computer system within a data center or on a network.

Approaches for implementing convention virtualization have required reconfiguration of each network switch within a datacenter with the IP addresses for the application and editing static configuration files for the applications. Implementations of the approaches for convention virtualization require that the reconfiguration be performed for every network switch within the network in order to be functional. Further, each of the static configuration files for the application needs to be revised, and the application must be repointed to the new static configuration file upon start of execution of the application on a different computer system within a datacenter.

### SUMMARY

The present disclosure describes methods and systems for network virtualization in a publish and subscribe middleware architecture. In one embodiment, the system comprises a virtual application executing within an execution module on a computer system, wherein the virtual application has a virtual address and the computer system has a logical address, a network virtualization module for managing message routing for the virtual application, a data forwarding plane for performing message routing for the virtual application, and a communication interface for identifying a correspondence between the virtual address and the logical address during message routing with the data forwarding plane and the virtual application.

In one embodiment, the forwarding plane routes messages to the virtual application based upon the virtual address. In another embodiment, the communication interface performs a translation between the virtual address and the logical address.

In other embodiments, the correspondence between the virtual address and the logical address is determined by performing a lookup to identify a mapping between the virtual address and the logical address. In a further embodiment, the virtual address is determined by performing a mapping of the computer system IP address to the subscription.

In another embodiment the method is implemented using a processor and a memory for network virtualization in a publish and subscribe middleware architecture. The method comprises executing a virtual application stored in memory on a computer system using the processor, wherein the virtual application has a virtual address and the computer system has a logical address, managing message routing for the virtual application using the processor, performing message routing for the virtual application using a data forwarding plane, and identifying a correspondence between the virtual address and the logical address during message routing with the data forwarding plane and the virtual application using the processor.

In another embodiment a computer program product is stored in a computer-readable storage medium which, when executed by a processing arrangement, is configured to provide network virtualization in a publish and subscribe middleware architecture. The computer program includes computer readable program code used to execute a virtual application on a computer system, wherein the virtual application has a virtual address and the computer system has a logical address, computer readable program code used to manage message routing for the virtual application, computer readable program code used to perform message routing for the virtual application using a data forwarding plane, and computer readable program code used to identify a correspondence between the virtual address and the logical address during message routing with the data forwarding plane and the virtual application

These and other embodiments of the present disclosure are described in further detail below.

### BRIEF DESCRIPTION OF THE DRAWINGS

The invention is described by way of example(s) with reference to the accompanying drawings, wherein:

FIG. 1A depicts an exemplary embodiment of an architecture for an implementation of network virtualization;

FIG. 1B is a flowchart for an exemplary embodiment of network virtualization;

FIG. 1C is a flowchart for an exemplary embodiment of network virtualization;

FIG. 1D illustrates an end-to-end middleware architecture in accordance with the principles of the present invention.

FIG. 1E is a diagram illustrating an overlay network.

FIG. 2A is a diagram illustrating an enterprise infrastructure implemented with an end-to-end middleware architecture according to the principles of the present invention.

FIG. 2B is a diagram illustrating an enterprise infrastructure physical deployment with the message appliances (MAS) creating a network backbone disintermediation.

FIG. 3 illustrates a channel-based messaging system architecture.

FIG. 4 illustrates one possible topic-based message format.

FIG. 5 shows a topic-based message routing and routing table.

FIG. 6 depicts an exemplary block diagram for a system architecture of a computer system.

### DETAILED DESCRIPTION OF THE INVENTION

Embodiments of the present invention provide virtualization of network traffic by allowing for the dynamic allocation of IP addresses. In one or more embodiments, an application may have a virtual IP address that differs from the IP address for the computer system on which the application is executing, and the application is capable of sending and receiving messages with the virtual IP address without the need to update an IP address in a network switch and/or configuration files for the application. Implementations of network virtualization in accordance with the present application allow an application to decouple their IP address from a computer system on which it is executing and allow the application to have its' own virtual IP address.

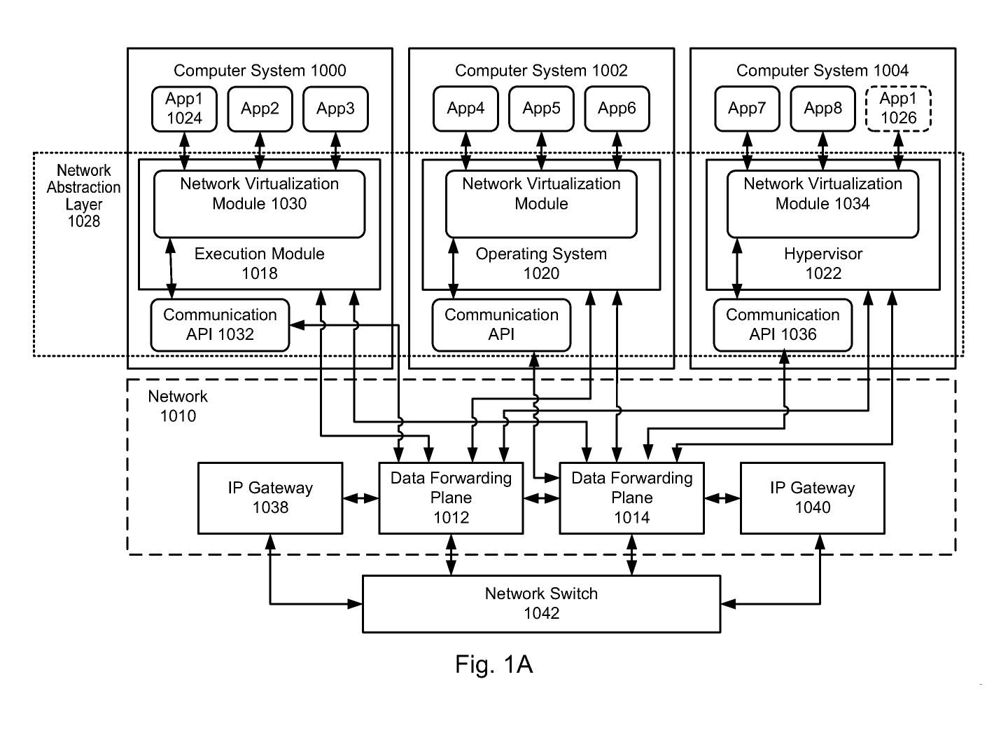

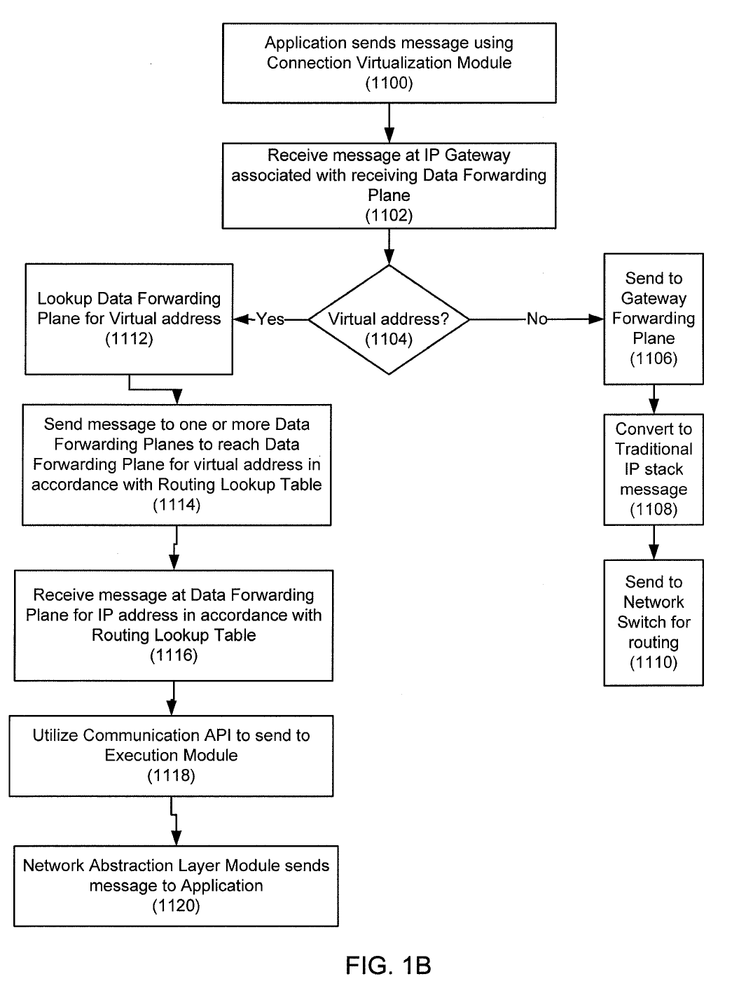

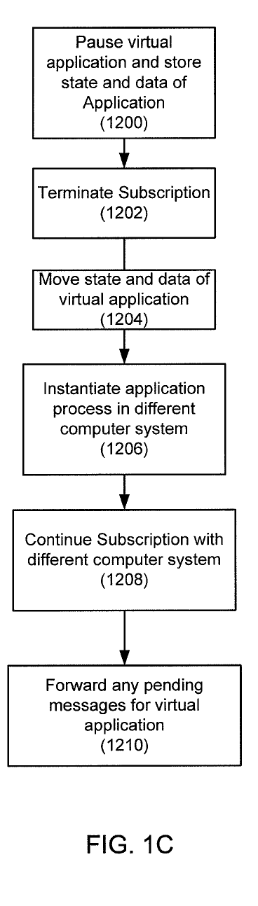

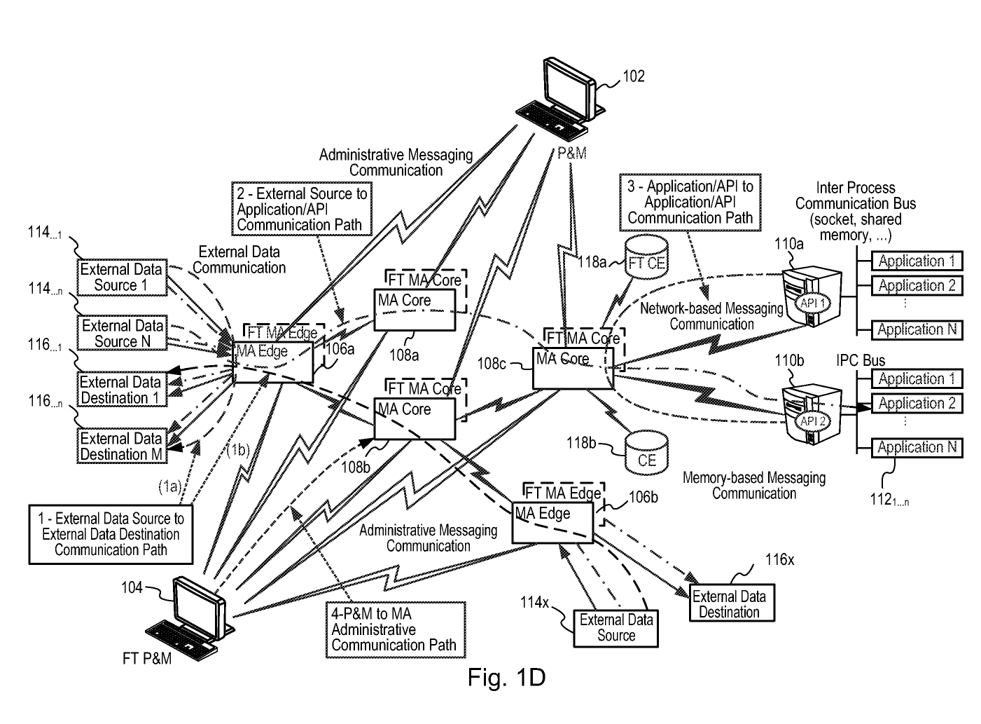

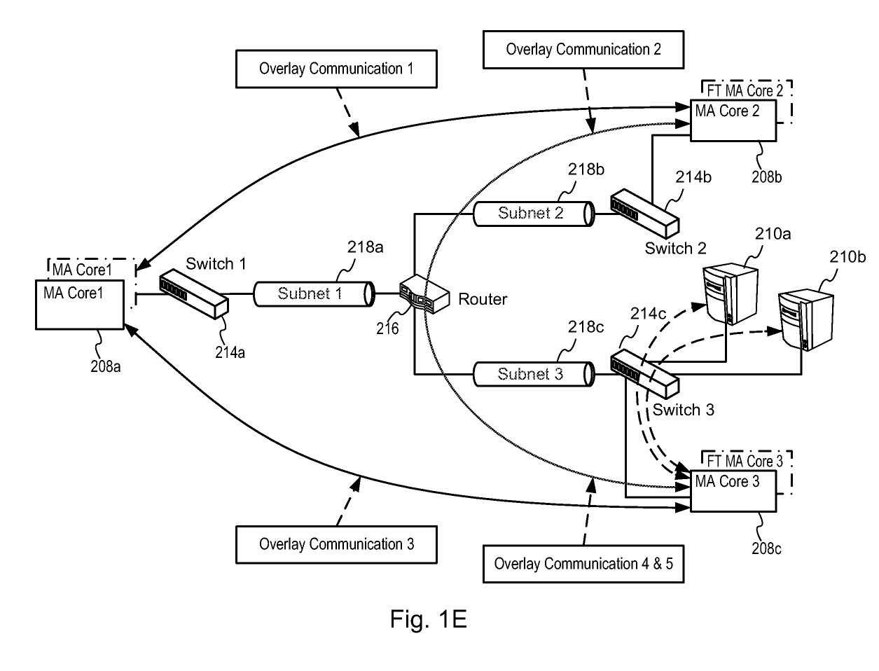

FIG. 1A depicts an exemplary embodiment of an architecture for an implementation of network virtualization. Computer Systems 1000, 1002, and 1004 may communicate with Data Forwarding Planes 1006 and 1008 over a Network 1010. A Network 1010 is an infrastructure for sending and receiving signals and messages according to one or more formats, standards, or protocols. The Network 1010 may provide for both wired and wireless communication between the various elements of FIG. 1A. Embodiments may rely on a Network 1010 for communication between elements as depicted, including, but not limited to, Computer Systems 1000, 1002, and 1004, and Data Forwarding Planes 1012 and 1014. The Network 1010 may be implemented as the following, but not limited to, a private network and an L2/L3 Network.

The Data Forwarding Planes 1012 and 1014 provide for message routing in a publish and subscribe middleware architecture, described in more detail with FIGS. 1D-5. An example of an end-to-end publish/subscribe middleware architecture is described in U.S. patent application Ser. No. 11/316,778 entitled “End-to-End Publish/Subscribe Middleware Architecture,” by Thompson et al., filed on Dec. 23, 2005. In one or more embodiments, the Data Forwarding Planes 1012 and 1014 may be groups of data plane modules of a Messaging Appliance, as described in U.S. patent application Ser. No. 11/317,295 entitled “Hardware-Based Messaging Appliance,” by Thompson, et al., filed on Dec. 23, 2005, which is hereby incorporated herein by reference, and as such, the terms Data Forwarding Plane and Message Appliance (MA) may be used interchangeably throughout the application.

In FIG. 1A, Applications entitled “App1,” “App2,” and “App3” are applications executing on Computer System 1000 within an Execution Module 1018. Implementations of an Execution Module 1018 may include, but are not limited to, the following: Hypervisors, Operating Systems, VmWare's virtual machine software, and Execution Containers, such as Execution Containers provided by Librato (C). A hypervisor, also called virtual machine monitor (VMM), is a computer hardware platform virtualization software that allows multiple operating systems to run on a host computer concurrently. By way of example, applications entitled “App4,” “App5,” and “App6” are executing with an Operating System 1020, an example of an implementation of an Execution Container, and applications entitled “App7,” and “App8,” are executing within a Hypervisor 1022.

Applications executing within Execution Modules 1018, 1020, and 1022 may be any type of virtual application for implementations of network virtualization. A virtual application may be any application that has been optimized to run on virtual infrastructure, such as a Hypervisor or Execution Container. By way of example, application 1024 entitled “App1” may be a virtual machine with a virtual IP address executing within Execution Module 1018. Application “App1” may be aware of its' own virtual IP address for sending and receiving messages but unaware of the IP address of the computer system on which it is executing. A “virtual address” is a address for a virtual application that differs from the logical address for a computer system, such as a virtual IP address for use with IP systems, and will be used interchangeably throughout. Application 1024 entitled “App1” may be said to have a decoupled virtual address from the IP address for the computer system on which it is executing. By way of further example, the decoupling of the virtual address from the computer system IP address may allow for the movement of “App1” executing on Computer System 1004 to Computer System 1000.

A Network Abstraction Layer 1028 may provide the capability to decouple an application's virtual address from the computer system IP address on which it is executing. The Network Abstraction Layer 1028 may be a software module and/or application programming interface (API) that provides network virtualization. The Network Abstraction Layer 1028 may be accessible by an Execution Container 1018. In one or more embodiments, the Network Abstraction Layer 1028 may be implemented as a Network Virtualization Module 1030 which is software that sits between an application 1024 and the Execution Module 1018.

The Network Virtualization Module 1030 may manage registration of the application with a Data Forwarding Plane 1012, manage sending and receiving messages within a publish and subscribe middleware architecture, and coordinate translations between the virtual address of the application 1024 and the IP address of the Computer System 1000. By way of example, the Network Virtualization Module 1030 is incorporated into the Execution Module 1018 on Computer System 1000. Those skilled in the art will recognize that the functionality of the network virtualization module may be implemented in a variety of ways. For example, the network virtualization module may be a part of the virtual application or communication API. Network Virtualization Module 1030 may rely on a Communication API 1032 to encapsulate or ensure that the application is unaware of the translation from a virtual address to the computer system IP address. In one or more embodiments, the Communication API may rely on a (e.g., Tervela™) message protocol to send and receive messages in the publish/subscribe middleware architecture. An example of a Communication API is provided in U.S. patent application Ser. No. 11/317,280 entitled “Intelligent Messaging Application Programming Interface,” by Thompson et al., filed on Dec. 23, 2005, incorporated by reference herein in its entirety. Application 1024 may request to send a message using the application's virtual address using the Network Virtualization Module 1030 and the Network Virtualization Module 1030 may utilize the Communication API 1032 to request that the Data Forwarding Plane 1012 to send the message and that a response to the message be received for the virtual address of the application. The application may only be aware that an IP protocol procedure or function call is being made and the Network Virtualization Module 1030 may handle the call using the Communication API 1032 to encapsulate the IP packet as well as the IP address.

The Network Virtualization Module 1030 may use the Communication API 1032 to register the Virtual address (for example, Virtual address a.b.c.d) for application 1024. In one or more embodiments, the Virtual address is registered as a topic with the Data Forwarding Plane 1012 using the Communication API 1032. Topics are used for publish/subscribe messaging to define shared access domains and the targets for a message, and therefore a subscription to one or more topics permits reception and transmission of messages with such topic notations. Topics and topic routing is described below in more detail with FIGS. 1D-5.

Once the virtual address of application 1024 is registered as a topic, the application 1024 can be moved to any computer system within a datacenter or within a network supported by Data Forwarding Planes 1012 and 1014. By way of example, in FIG. 1A, if it is desired that virtual application 1026 entitled “AppI” on Computer System 1004 be paused and moved to Computer System 1004, then Network Virtualization Module 1034 would utilize Communication API 1036 to terminate the subscription for the virtual address for application 1026 associated with the IP address for Computer System 1004. The application entitled “App1” may then be instantiated on Computer System 1000, depicted as “App1” 1024. After execution of application “App1” 1026 has resumed depicted as “App1” 1026 on Computer System 1000, then the application 1024 may be registered as a topic with the same virtual address (as used on Computer System 1004) and be associated with the IP address of Computer System 1000. The registration by the application by the Network Virtualization Module 1030 may be done with the nearest Data Forwarding Plane 1012 and the routing information for the topic may be propagated to other Data Forwarding Planes within the datacenter or available on a network. In this way an application can be moved anywhere in datacenter and only be aware that it has the same virtual address. The data forwarding plane dynamically allocates an IP address without need to alert a networking switch using the publish/subscribe network architecture.

In one or more embodiments, the Data Forwarding Plane 1012 may utilize an IP Gateway 1038 to handle network traffic that does not involve topic routing and/or virtual addresses, and may be forwarded to a Network Switch for IP processing. The IP Gateway 1038 may be said to de-encapsulate the IP traffic and push the IP message to a traditional network switch. In one or more embodiments, the IP Gateway 1038 may cause a Data Forwarding Plane 1012 to forward the message to an Edge MA.

The Data Forwarding Plane 1012 may handle message delivery involving virtual addresses by performing a lookup with the topic routing table and sending the message to the Computer System associated with the topic or virtual address in the topic routing table. For example, Data Forwarding Plane 1012 may receive a message sent by “App1” at Computer System 1000 to “App7” at Computer System 1004 because the Data Forwarding Plane 1012 is the nearest data forwarding plane and the Data Forwarding Plane 1012 may pass the message to Data Forwarding Plane 1014 over the network for deliver to “App7” on Computer System 1004.

FIG. 1B is a flowchart for an exemplary embodiment of network virtualization. Initially, an application sends a message using a Network Virtualization Module (1100). The Network Virtualization Module 1030 uses the Communication API 1032 to encapsulate the message and the mapping of the virtual address to the Computer System IP address for 1000. The message may be sent to the nearest Data Forwarding Plane 1012.

Next, the IP Gateway 1038 associated with the Data Forwarding Plane 1012 may receive the message (1102). The IP Gateway 1038 may determine whether a message involves a virtual address (1104). If the message does not involve a virtual address (1104), then the message is sent to a gateway forwarding plane (1106). For simplicity's sake, the Data Forwarding Plane 1012 connected to Network Switch 1042 in FIG. 1A may be viewed as a gateway forwarding plane. In one or more embodiments, a gateway forwarding plane is an Edge MA. Next, the messages is converted into a traditional IP stack message (1108) and sent to a Network Switch for routing (1110).

Continuing with FIG. 1B, if the message involves a virtual address (1104), then a lookup is performed at the Data Forwarding Plane 1012 (1112). A lookup may be performed with a topic routing table to determine the IP address for the computer system associated with the virtual address. By way of example, if the message is sent to the virtual address for “App7” in FIG. 1A, then the IP address for Computer System 1004 may be retrieved with the topic routing lookup table.

Next, the message may propagate through one or more data forwarding planes to reach the data forwarding plane for the virtual address in accordance with the topic routing lookup table (1114). After the data forwarding plane for the IP address retrieved with the routing lookup table receives the message (1116), the communication API may be used to send the message to the execution module associated with the application that has the virtual address (1118).

The network virtualization module may then send the message to the application with the virtual address indicated to be the IP address for the receiving application (1120).

FIG. 1C is a flowchart for an exemplary embodiment of network virtualization. FIG. 1C depicts the ability to move an executing virtual application from one computer system to another computer system without the need to reconfigure a network switch. Initially, the virtual application is paused and the state and data associated with the executing application is stored (1200).

Next, the subscription is terminated (1202). The network virtualization module may terminate the subscription using the communication API. The data forwarding planes may then store all messages for the virtual address with a terminated subscription in a cache.

Next, the state and data for the application may be moved to the new computer system that the application will execute on (1204). In one or more embodiments, the memory associated with the application that may store the state and data for the virtual application is copied and moved as a single block of information to move to different computer system (1204).

Next, the virtual application process may be instantiated on a different computer system (1206) and the execution of the paused application may then be resumed. The subscription may then be continued with a registration associating the virtual address with the IP address of the different computer system (1208). In one or more embodiments, continuing a subscription is accomplished by registering the virtual address as a topic on the data forwarding plane. In some embodiments, any pending messages for the virtual application are forwarded from a cache to the application by propagating the messages through one or more data forwarding planes.

Before outlining the details of various embodiments in accordance with aspects and principles of the present invention the following is a brief explanation of some terms that may be used throughout this description. It is noted that this explanation is intended to merely clarify and give the reader an understanding of how such terms might be used, but without limiting these terms to the context in which they are used and without limiting the scope of the claims thereby.

The term “middleware” is used as a general term for software that mediates between one or more software modules or applications. Middleware may provide messaging services so that different applications can communicate. The systematic tying together of disparate applications, often through the use of middleware, may be known as enterprise application integration (EAI). In this context, however, “middleware” can be a broader term used in the context of messaging between source and destination and the facilities deployed to enable such messaging; and, thus, middleware architecture covers the networking and computer hardware and software components that facilitate effective data messaging, individually and in combination as will be described below.

Moreover, the terms “messaging system” or “middleware system,” can be used in the context of publish/subscribe systems in which messaging servers manage the routing of messages between publishers and subscribers. It can also be used in the context of message forwarding and/or any interest based message propagation.

The term “consumer” may be used in the context of applications, virtual applications, execution modules, and the like. In one instance a consumer is a system or an application that uses the communication API to register to a middleware system, to subscribe to information, and to receive data delivered by the middleware system.

The term “external data source” may be used in the context of data distribution and message publish/subscribe systems. In one instance, an external data source is regarded as a system or application, located within or outside the enterprise private network, which publishes messages in one of the common protocols or its own message protocol. An example of an external data source is a market data exchange that publishes stock market quotes which are distributed to traders via the middleware system. As will be later described in more detail, the middleware architecture may adopt its unique native protocol to which data from external data sources may be converted once it enters the middleware system domain, thereby avoiding multiple protocol transformations.

The term “external data destination” is also used in the context of data distribution and message publish/subscribe systems. An external data destination is, for instance, a system or application, located within or outside the enterprise private network, which is subscribing to information routed via a local/global network. One example of an external data destination could be the aforementioned market data exchange that handles transaction orders published by the traders. Note that, in the foregoing middleware architecture messages directed to an external data destination are translated from the native protocol to the external protocol associated with the external data destination.

As can be ascertained from the description herein, the present invention can be practiced in various ways with various configurations. An example of a publish/subscribe middleware architecture that may be used in practicing the present invention is provided in U.S. patent application Ser. No. 11/316,778 entitled “End-to-End Publish/Subscribe Middleware Architecture,” by Thompson et al., filed on Dec. 23, 2005 and incorporated by reference herein is shown in FIG. 1D and described below.

The exemplary architecture may combine a number of beneficial features which include: messaging common concepts, APIs, fault tolerance, provisioning and management (P&M), quality of service (QoS—conflated, best-effort, guaranteed-while-connected, guaranteed-while disconnected etc.), persistent caching for guaranteed delivery QoS, management of namespace and security service, a publish/subscribe ecosystem (core, ingress and egress components), transport-transparent messaging, neighbor-based messaging (a model that is a hybrid between hub-and-spoke, peer-to-peer, and store-and-forward, and which uses a subscription-based routing protocol that can propagate the subscriptions to all neighbors as necessary), late schema binding, partial publishing (publishing changed information only as opposed to the entire data) and dynamic allocation of network and system resources. Note that the core MAs portion of the publish/subscribe ecosystem may uses the aforementioned native messaging protocol (native to the middleware system) while the ingress and egress portions, the edge MAs, may translate to and from this native protocol, respectively.

In addition to the publish/subscribe system components, the diagram of FIG. 1D shows the logical connections and communications between them. As can be seen, the illustrated middleware architecture is that of a distributed system. In a system with this architecture, a logical communication between two distinct physical components is established with a message stream and associated message protocol. The message stream contains one of two categories of messages: administrative and data messages. The administrative messages are used for management and control of the different physical components, management of subscriptions to data, and more. The data messages are used for transporting data between sources and destinations, and in a typical publish/subscribe messaging there are multiple senders and multiple receivers of data messages.

With the structural configuration and logical communications as illustrated the distributed publish/subscribe system with the middleware architecture is designed to perform a number of logical functions. One logical function is message protocol translation which is advantageously performed at an edge messaging appliance (MA) component. A second logical function is routing the messages from publishers to subscribers. Note that the messages are routed throughout the publish/subscribe network. Thus, the routing function is performed by each MA where messages are propagated, say, from an edge MA 106a-b (or API) to a core MA 108a-c or from one core MA to another core MA and eventually to an edge MA (e.g., 106b) or API 110a-b. The API 110a-b communicates with applications 112i-n via an inter-process communication bus (sockets, shared memory etc.). A third logical function is storing messages for different types of guaranteed-delivery quality of service, including for instance guaranteed-while-connected and guaranteed-while disconnected. A fourth function is delivering these messages to the subscribers. As shown, an API 106a-b delivers messages to subscribing applications 112i-n.

In this publish/subscribe middleware architecture, the system configuration function as well as other administrative and system performance monitoring functions are managed by the P&M system. Additionally, the MAs are deployed as edge MAs or core MAs, depending on their role in the network. An edge MA is similar to a core MA in most respects, except that it includes a protocol translation engine that transforms messages from external to native protocols and from native to external protocols. Thus, in general, the boundaries of the publish/subscribe system middleware architecture are characterized by its edges at which there are edge MAs 106a-b and APIs 110a-b; and within these boundaries there are core MAs 108a-c.

The core MAs 108a-c may route the published messages internally within the system towards the edge MAs or APIs (e.g., APIs 1I0a-b). The routing map, particularly in the core MAs, is designed for maximum volume, low latency, and efficient routing. Moreover, the routing between the core MAs can change dynamically in real-time. For a given messaging path that traverses a number of nodes (core MAs), a real time change of routing is based on one or more metrics, including network utilization, overall end-to-end latency, communications volume, network delay, loss and jitter.

Alternatively, instead of dynamically selecting the best performing path out of two or more diverse paths, the MA can perform multi-path routing based on message replication and thus send the same message across all paths. All the MAs located at convergence points of diverse paths will drop the duplicated messages and forward only the first arrived message. This routing approach has the advantage of optimizing the messaging infrastructure for low latency; although the drawback of this routing method is that the infrastructure requires more network bandwidth to carry the duplicated traffic.

Note that the system architecture is not confined to a particular limited geographic area and, in fact, is designed to transcend regional or national boundaries and even span across continents. In such cases, the edge MAs in one network can communicate with the edge MAs in another geographically distant network via existing networking infrastructures.

The edge MAs have the ability to convert any external message protocol of incoming messages to the middleware system's native message protocol; and from native to external protocol for outgoing messages. That is, an external protocol is converted to the native (e.g., Tervela™) message protocol when messages are entering the publish/subscribe network domain (ingress); and the native protocol is converted into the external protocol when messages exit the publish/subscribe network domain (egress). Another function of edge MAs is to deliver the published messages to the subscribing external data destinations.

Additionally, both the edge and the core MAs 106a-b and 108a-c are capable of storing the messages before forwarding them. One way this can be done is with a caching engine (CE) 118a-b. One or more CEs can be connected to the same MA. Theoretically, the API is said not to have this store-and-forward capability although in reality an API 110a-b could store messages before delivering them to the application, and it can store messages received from applications before delivering them to a core MA, edge MA or another API.

When an MA (edge or core MA) has an active connection to a CE, it forwards all or a subset of the routed messages to the CE which writes them to a storage area for persistency. For a predetermined period of time, these messages are then available for retransmission upon request. Examples where this feature is implemented are data replay, partial publish and various quality of service levels. Partial publish may be effective in reducing network and consumers load because it may involve transmission of only of updated information rather than of all information.

To illustrate how the routing maps might effect routing, a few examples of the publish/subscribe routing paths are shown in FIG. 1D. In this illustration, the middleware architecture of the publish/subscribe network provides five or more different communication paths between publishers and subscribers.

The first communication path links an external data source to an external data destination. The published messages received from the external data source 114i-n are translated into the native (e.g., Tervela™) message protocol and then routed by the edge MA 106a. One way the native protocol messages can be routed from the edge MA 106a is to an external data destination 116n. This path is called out as communication path 1a. In this case, the native protocol messages are converted into the external protocol messages suitable for the extra data destination. Another way the native protocol messages can be routed from the edge MA 106b is internally through a core MA 108b. This path is called out as communication path 1b. Along this path, the core MA I08b routes the native messages to an edge MA 106a. However, before the edge MA 106a routes the native protocol messages to the external data destination 116i, it converts them into an external message protocol suitable for this external data destination 116i. As can be seen, this communication path doesn't require the API to route the messages from the publishers to the subscribers.

Another communication path, called out as communications path 2, links an external data source 114n to an application using the API 110b. Published messages received from the external data source are translated at the edge MA 106a into the native message protocol and are then routed by the edge MA to a core MA 108a. From the first core MA 108a, the messages are routed through another core MA 108c to the API 110b. From the API the messages are delivered to subscribing applications (e.g., 1122). Because the communication paths are bidirectional, in another instance, messages could follow a reverse path from the subscribing applications 112i-n to the external data destination 116n. In each instance, core MAs receive and route native protocol messages while edge MAs receive external or native protocol messages and, respectively, route native or external protocol messages (edge MAs translate to/from such external message protocol to/from the native message protocol). Each of the edge MAs can route an ingress message simultaneously to both native protocol channels and external protocol channels. As a result, each edge MA can route an ingress message simultaneously to both external and internal consumers, where internal consumers consume native protocol messages and external consumers consume external protocol messages. This capability enables the messaging infrastructure to seamlessly and smoothly integrate with legacy applications and systems.

Yet another communication path, called out as communications path 3, links two applications, both using an API 110a-b. At least one of the applications publishes messages or subscribes to messages. The delivery of published messages to (or from) subscribing (or publishing) applications is done via an API that sits on the edge of the publish/subscribe network. When applications subscribe to messages, one of the core or edge MAs routes the messages towards the API which, in turn, notifies the subscribing applications when the data is ready to be delivered to them. Messages published from an application are sent via the API to the core MA 108c to which the API is ‘registered’.

Note that by ‘registering’ (logging in) to an MA, the API becomes logically connected to it. An API initiates the connection to the MA by sending a registration (a ‘log-in’ request) message to the MA. After registration, the API can subscribe to particular topics of interest by sending its subscription messages to the MA. Topics are used for publish/subscribe messaging to define shared access domains and the targets for a message, and therefore a subscription to one or more topics permits reception and transmission of messages with such topic notations. The P&M sends to the MAs in the network periodic entitlement updates and each MA updates its own table accordingly. Hence, if the MA find the API to be entitled to subscribe to a particular topic (the MA verifies the API's entitlements using the routing entitlements table) the MA activates the logical connection to the API. Then, if the API is properly registered with it, the core MA 108c routes the data to the second API 110 as shown. In other instances this core MA 108b may route the messages through additional one or more core MAs (not shown) which route the messages to the API 110b that, in turn, delivers the messages to subscribing applications 112i-n.

As can be seen, communications path 3 doesn't require the presence of an edge MA, because it doesn't involve any external data message protocol. In one embodiment exemplifying this kind of communications path, an enterprise system is configured with a news server that publishes to employees the latest news on various topics. To receive the news, employees subscribe to their topics of interest via a news browser application using the API.

Note that the middleware architecture allows subscription to one or more topics. Moreover, this architecture allows subscription to a group of related topics with a single subscription request, by allowing wildcards in the topic notation.

Yet another path, called out as communications path 4, is one of the many paths associated with the P&M system 102 and 104 with each of them linking the P&M to one of the MAs in the publish/subscribe network middleware architecture. The messages going back and forth between the P&M system and each MA are administrative messages used to configure and monitor that MA. In one system configuration, the P&M system communicates directly with the MAs. In another system configuration, the P&M system communicates with MAs through other MAs. In yet another configuration the P&M system can communicate with the MAs both directly or indirectly.

In a typical implementation, the middleware architecture can be deployed over a network with switches, router and other networking appliances, and it employs channel-based messaging capable of communications over any type of physical medium. One exemplary implementation of this fabric-agnostic channel-based messaging is an IP-based network. In this environment, all communications between all the publish/subscribe physical components are performed over UDP (User Datagram Protocol), and the transport reliability is provided by the messaging layer. An overlay network according to this principle as provided in is illustrated in FIG. 1E.

As shown, overlay communications 1, 2 and 3 can occur between the three core MAs 208a-c via switches 214a-c, a router 216 and subnets 218a-c. In other words, these communication paths can be established on top of the underlying network which is composed of networking infrastructure such as subnets, switches and routers, and, as mentioned, this architecture can span over a large geographic area (different countries and even different continents).

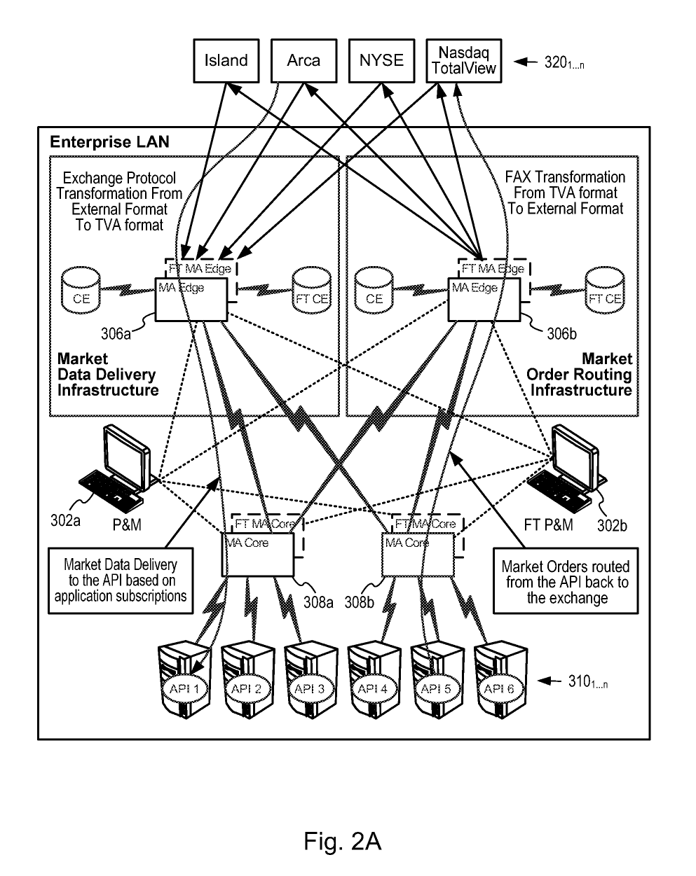

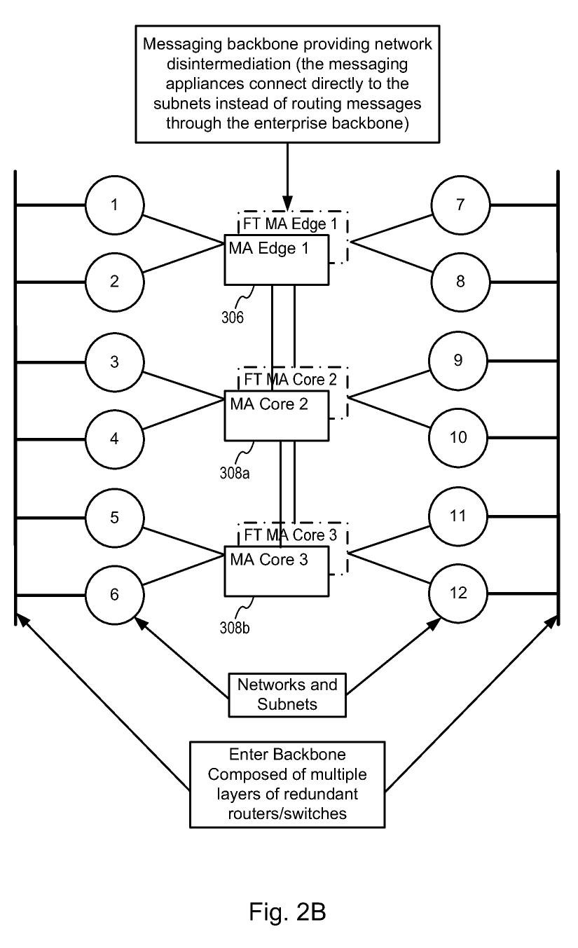

Notably, the foregoing and other end-to-end middleware architectures according to the principles of the present invention can be implemented in various enterprise infrastructures in various business environments. One such implementation is illustrated on FIG. 2A as provided in U.S. patent application Ser. No. 11/316,778 entitled “End-to-End Publish/Subscribe Middleware Architecture,” by Thompson et al., filed on Dec. 23, 2005, incorporated by reference herein in its entirety.

In this enterprise infrastructure, a market data distribution plant 12 is built on top of the publish/subscribe network for routing stock market quotes from the various market data exchanges 320i-n to the traders (applications not shown). Such an overlay solution relies on the underlying network for providing interconnects, for instance, between the MAs as well as between such MAs and the P&M system. Market data delivery to the APIs 310i-n is based on applications subscription. With this infrastructure, traders using the applications (not shown) can place transaction orders that are routed from the APIs 310i-n through the publish/subscribe network (via core MAs 308a-b and the edge MA 306b) back to the market data exchanges 320i-n.

An example of the underlying physical deployment is illustrated on FIG. 2B as provided in U.S. patent application Ser. No. 11/316,778 entitled “End-to-End Publish/Subscribe Middleware Architecture,” by Thompson et al., filed on Dec. 23, 2005, incorporated by reference herein in its entirety. As shown, the MAs are directly connected to each other and plugged directly into the networks and subnets in which the consumers and publishers of messaging traffic are physically connected. In this case, interconnects would be the direct connections, say, between the MAs as well as between them and the P&M system. This enables a network backbone disintermediation and a physical separation of the messaging traffic from other enterprise applications traffic. Effectively, the MAs can be used to remove the reliance on traditional routed network for the messaging traffic.

In this example of physical deployment, the external data sources or destinations, such as market data exchanges, are directly connected to edge MAs, for instance edge MA 1. The consuming or publishing applications of messaging traffic, such as market trading applications, are connected to the subnets 1-12. These applications have at least two ways to subscribe, publish or communicate with other applications. The application could either use the enterprise backbone, composed of multiple layers of redundant routers and switches, which carries all enterprise application traffic, such as messaging traffic, or use the messaging backbone, composed of edge and core MAs directly interconnected to each other via an integrated switch. Using an alternative backbone has the benefit of isolating the messaging traffic from other enterprise application traffic, and thus better controlling the performance of the messaging traffic. In one implementation, an application located in subnet 6 logically or physically connected to the core MA 3, subscribes to or publishes messaging traffic in the native protocol, using the Tervela API. In another implementation, an application located in subnet 7 logically or physically connected to the edge MA 1, subscribes to or publishes the messaging traffic in an external protocol, where the MA performs the protocol transformation using the integrated protocol transformation engine module.

Logically, the physical components of the publish/subscribe network are built on a messaging transport layer akin to layers 1 to 4 of the Open Systems Interconnection (OSI) reference model. Layers 1 to 4 of the OSI model are respectively the Physical, Data Link, Network and Transport layers.

Thus, in one embodiment of the invention, the publish/subscribe network can be directly deployed into the underlying network fabric by, for instance, inserting one or more messaging line card in all or a subset of the network switches and routers. In another embodiment of the invention, the publish/subscribe network can be deployed as a mesh overlay network (in which all the physical components are connected to each other). For instance, a fully-meshed network of 4 MAs is a network in which each of the MAs is connected to each of its 3 peer MAs. In a typical implementation, the publish/subscribe network is a mesh network of one or more external data sources and/or destinations, one or more provisioning and management (P&M) systems, one or more messaging appliances (MAs), one or more optional caching engines (CE) and one or more optional application programming interfaces (APIs).

As will be later explained in more detail, reliability, availability and consistency are often necessary in enterprise operations. For this purpose, the publish/subscribe system can be designed for fault tolerance with several of its components being deployed as fault tolerant systems. For instance, MAs can be deployed as fault-tolerant MA pairs, where the first MA is called the primary MA, and the second MA is called the secondary MA or fault-tolerant MA (FT MA). Again, for store and forward operations, the CE (cache engine) can be connected to a primary or secondary core/edge MA. When a primary or secondary MA has an active connection to a CE, it forwards all or a subset of the routed messages to that CE which writes them to a storage area for persistency. For a predetermined period of time, these messages are then available for retransmission upon request.

Notably, communications throughout the publish/subscribe network are conducted using the native protocol messages independently from the underlying transport logic and as such, the architecture may be referred to as a transport-transparent channel-based messaging architecture.

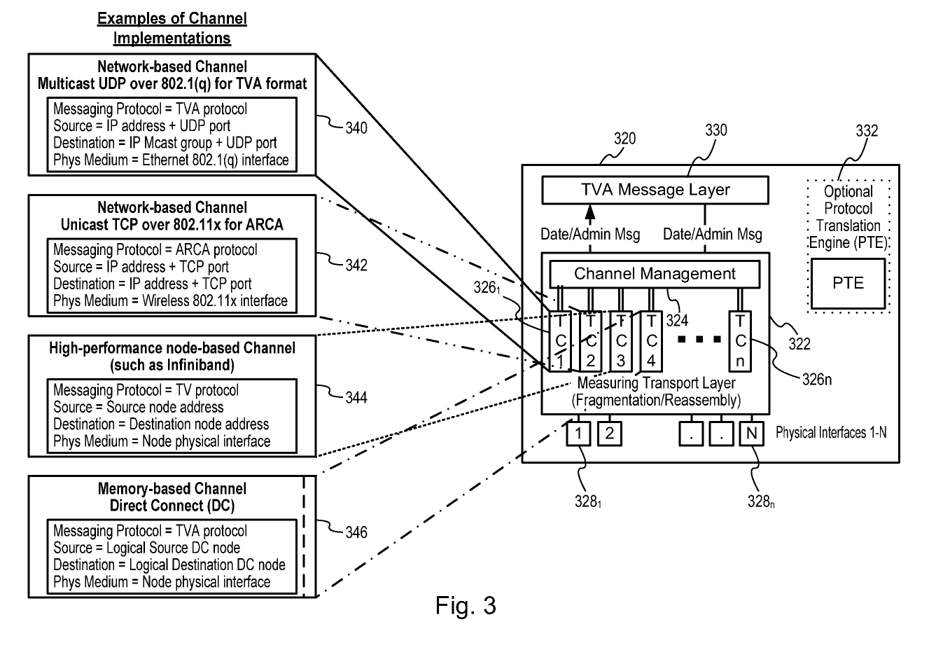

FIG. 3 illustrate in more details the channel-based messaging architecture 320 as provided in U.S. patent application Ser. No. 11/316,778 entitled “End-to-End Publish/Subscribe Middleware Architecture,” by Thompson et al., filed on Dec. 23, 2005, incorporated by reference herein in its entirety. Generally, each communication path between the messaging source and destination is considered a messaging transport channel. Each channel 326i-n, is established over a physical medium with interfaces 328i-n between the channel source and the channel destination. Each such channel is established for a specific message protocol, such as the native (e.g., Tervela™) message protocol or others. Only edge MAs (those that manage the ingress and egress of the publish/subscribe network) use the channel message protocol (external message protocol). Based on the channel message protocol, the channel management layer 324 determines whether incoming and outgoing messages require protocol translation. In each edge MA, if the channel message protocol of incoming messages is different from the native protocol, the channel management layer 324 will perform a protocol translation by sending the message for process through the protocol translation engine (PTE) 332 before passing them along to the native message layer 330. Also, in each edge MA, if the native message protocol of outgoing messages is different from the channel message protocol (external message protocol), the channel management layer 324 will perform a protocol translation by sending the message for process through the protocol translation engine (PTE) 332 before routing them to the transport channel 326i-n. Hence, the channel manages the interface 328i-n with the physical medium as well as the specific network and transport logic associated with that physical medium and the message reassembly or fragmentation.

In other words, a channel manages the OSI transport to physical layers 322. Optimization of channel resources is done on a per channel basis (e.g., message density optimization for the physical medium based on consumption patterns, including bandwidth, message size distribution, channel destination resources and channel health statistics). Then, because the communication channels are fabric agnostic, no particular type of fabric is required. Indeed, any fabric medium will do, e.g., ATM, Infiniband or Ethernet.

Incidentally, message fragmentation or re-assembly may be needed when, for instance, a single message is split across multiple frames or multiple messages are packed in a single frame Message fragmentation or reassembly is done before delivering messages to the channel management layer.

FIG. 3 further illustrates a number of possible channels implementations in a network with the middleware architecture. In one implementation 340, the communication is done via a network-based channel using multicast over an Ethernet switched network which serves as the physical medium for such communications. In this implementation the source send messages from its IP address, via its UDP port, to the group of destinations (defined as an IP multicast address) with its associated UDP port. In a variation of this implementation 342, the communication between the source and destination is done over an Ethernet switched network using UDP unicast. From its IP address, the source sends messages, via a UDP port, to a select destination with a UDP port at its respective IP address.

In another implementation 344, the channel is established over an Infiniband interconnect using a native Infiniband transport protocol, where the Infiniband fabric is the physical medium. In this implementation the channel is node-based and communications between the source and destination are node-based using their respective node addresses. In yet another implementation 346, the channel is memory-based, such as RDMA (Remote Direct Memory Access), and referred to here as direct connect (DC). With this type of channel, messages are sent from a source machine directly into the destination machine's memory, thus, bypassing the CPU processing to handle the message from the NIC to the application memory space, and potentially bypassing the network overhead of encapsulating messages into network packets.

As to the native protocol, one approach uses the aforementioned native Tervela™ message protocol. Conceptually, the Tervela™ message protocol is similar to an IP-based protocol. Each message contains a message header and a message payload. The message header contains a number of fields one of which is for the topic information. As mentioned, a topic is used by consumers to subscribe to a shared domain of information.

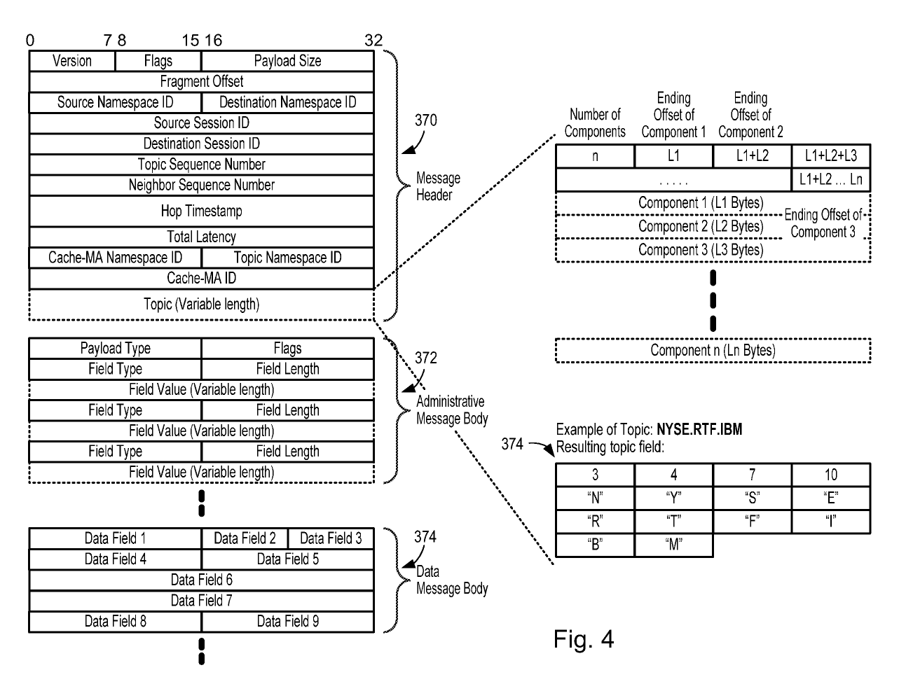

FIG. 4 illustrates one possible topic-based message format as provided in U.S. patent application Ser. No. 11/316,778 entitled “End-to-End Publish/Subscribe Middleware Architecture,” by Thompson et al., filed on Dec. 23, 2005, incorporated by reference herein in its entirety. As shown, messages include a header 370 and a body 372 and 374 which includes the payload. The two types of messages, data and administrative are shown with different message bodies and payload types. The header includes fields for the source and destination namespace identifications, source and destination session identifications, topic sequence number and hope timestamp; and, in addition, it includes the topic notation field (which is preferably of variable length). The topic might be defined as a token-based string, such as NYSE.RTF.IBM 376 which is the topic string for messages containing the real time quote of the IBM stock.

In some embodiment, the topic information in the message might be encoded or mapped to a key, which can be one or more integer values. Then, each topic would be mapped to a unique key, and the mapping database between topics and keys would be maintained by the P&M system and updated over the wire to all MAs. As a result, when an API subscribes or publishes to one topic, the MA is able to return the associated unique key that is used for the topic field of the message.

Preferably, the subscription format will follow the same format as the message topic. However, the subscription format also supports wildcards that match any topic substring or regular expression pattern-match against the topic. Handling of wildcard mapping to actual topics may be dependant on the P&M subsystem or handled by the MA depending on complexity of the wildcard or pattern-match request. For instance, such pattern matching rules could be:

### Example #1

A string with a wildcard of T1.*.T3.T4.* would match T1.T2a.T3.T4 and T1.T2b.T3.T4 but would not match T1.T2.T3.T4.T5

### Example #2

A string with wildcards of TI.*.T3.T4.* would not match T1.T2a.T3.T4 and TI.T2b.T3.T4 but it would match T1.T2.T3.T4.T5

### Example #3

A string with wildcards of T1.*.T3.T4[*] (optional 5^{th} element) would match T1.T2a.T3.T4, T1.T2b.T3.T4 and T1.T2.T3.T4.T5 but would not match T1.T2.T3.T4.T5.T6

### Example #4

A string with a wildcard of T1.T2*.T3.T4 would match T1.T2a.T3.T4 and T1.T2b.T3.T4 but would not match T1.T5a.T3.T4

### Example #5

A string with wildcards of TI.*.T3.T4.> (any number of trailing elements) would match T1.T2a.T3.T4, T1.T2b.T3.T4, T1.T2.T3.T4.T5 and T1.T2.T3.T4.T5.T6.

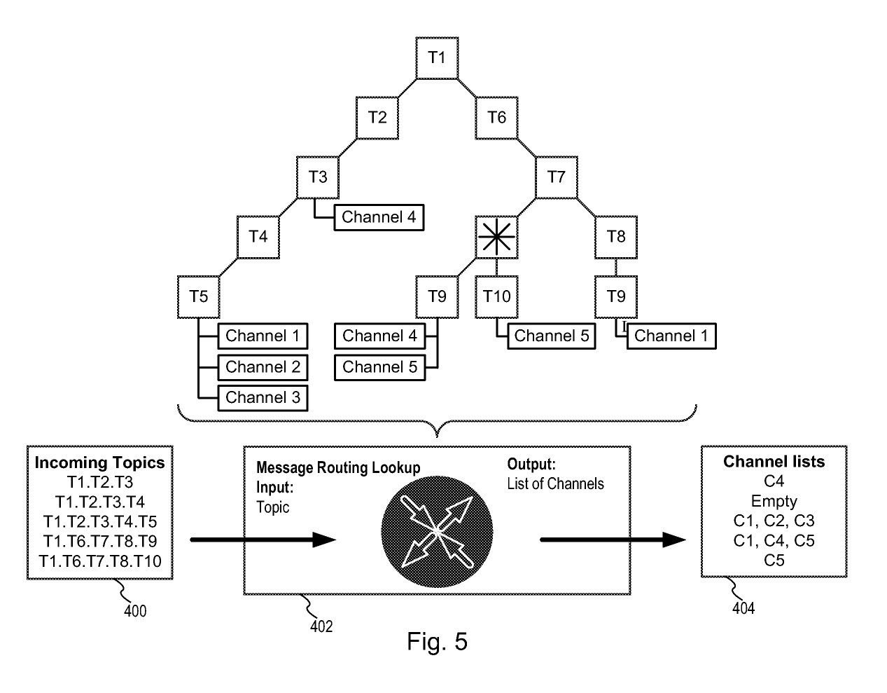

FIG. 5 shows topic-based message routing as provided in U.S. patent application Ser. No. 11/316,778 entitled “End-to-End Publish/Subscribe Middleware Architecture,” by Thompson et al., filed on Dec. 23, 2005, incorporated by reference herein in its entirety. As indicated, a topic might be defined as a token-based string, such as T1.T2.T3.T4, where T1, T2, T3 and T4 are strings of variable lengths. As can be seen, incoming messages with particular topic notations 400 are selectively routed to communications channels 404, and the routing determination is made based on a routing table 402. The mapping of the topic subscription to the channel defines the route and is used to propagate messages throughout the publish/subscribe network. The superset of all these routes, or mapping between subscriptions ‘and channels, defines the routing table. The routing table is also referred to as the subscription table. The subscription table for routing via string based topics can be structured in a number of ways, but is preferably configured for optimizing its size as well as the routing lookup speed. In one implementation, the subscription table may be defined as a dynamic hash map structure, and in another implementation the subscription table may be arranged in a tree structure as shown in the diagram of FIG. 5.

A tree includes nodes (e.g., Ti, . . . TIO) connected by edges, where each sub-string of a topic subscription corresponds to a node in the tree. The channels mapped to a given subscription are stored on the leaf node of that subscription indicating, for each leaf node, the list of channels from where the topic subscription came (i.e., through which subscription requests were received). This list indicates which channel should receive a copy of the message whose topic notation matches the subscription. As shown, the message routing lookup takes a message topic as input and parse the tree using each substring of that topic to locate the different channels associated with the incoming message topic. For instance, T1, T2, T3, T4 and T5 are directed to channels 1, 2 and 3; T1, T2, and T3, are directed to channel 4; T1, T6, T7, T* and T9 are directed to channels 4 and 5; T1, T6, T7, T* and T9 are directed to channel 1; and T1, T6, T7, T* and T10 are directed to channel 5.

Although selection of the routing table structure is intended to optimize the routing table lookup, performance of the lookup depends also on the search algorithm for finding the one or more topic subscriptions that match an incoming message topic. Therefore, the routing table structure should be able to accommodate such algorithm and vice versa. One way to reduce the size of the routing table is by allowing the routing algorithm to selectively propagate the subscriptions throughout the entire publish/subscribe network. For example, if a subscription appears to be a subset of another subscription (e.g., a portion of the entire string) that has already been propagated, there is no need to propagate the subset subscription since the MAs already have the information for the superset of this subscription.

Based on the foregoing, the preferred message routing protocol is a topic-based routing protocol, where entitlements are indicated in the mapping between subscribers and respective topics. Entitlements are designated per subscriber or groups/classes of subscribers and indicate what messages the subscriber has a right to consume, or which messages may be produced (published) by such producer (publisher). These entitlements are defined in the P&M system, communicated to all MAs in the publish/subscribe network, and then used by the MA to create and update their routing tables.

Each MA updates its routing table by keeping track of who is interested in (requesting subscription to) what topic. However, before adding a route to its routing table, the MA has to check the subscription against the entitlements of the publish/subscribe network. The MA verifies that a subscribing entity, which can be a neighboring MA, the P&M system, a CE or an API, is authorized to do so. If the subscription is valid, the route will be created and added to the routing table. Then, because some entitlements may be known in advance, the system can be deployed with predefined entitlements and these entitlements can be automatically loaded at boot time. For instance, some specific administrative messages such as configuration updates or the like might be always forwarded throughout the network and therefore automatically loaded at startup time.

In addition to its role in the subscription process, the P&M system has a number of other management functions. These additional functions include publish/subscribe system configuration and health monitoring and reporting. Configuration involves both physical and logical configuration of the publish/subscribe system network and components. The monitoring and reporting involves monitoring the health of all network and system components and reporting the results automatically, per demand or to a log.

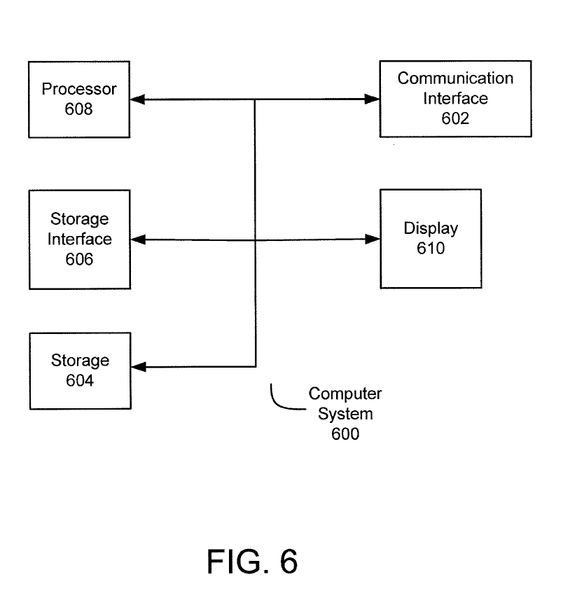

FIG. 6 depicts an exemplary block diagram for a system architecture of a computer system. The execution of instructions to practice the invention may be performed by any number of computer systems 600 as depicted in FIG. 6. As used herein, the term computer system is broadly used to describe any computing device that can store and independently run one or more programs, applications, scripts, or software processes. Implementations of the present invention may have a single computer system 600 or any number of computer systems 600.

Computer systems 600 may communicate with other computer systems/devices with any number of Communication Interface(s) 602. The Communication Interface 602 may provide the ability to transmit and receive signals, such as electrical, electromagnetic or optical signals, that include data streams representing various types of information (e.g., messages, communications, instructions, and data). The Communication Interface 602 may provide an implementation for a communication protocol, such as a network protocol. Instructions may be executed by a Processor 608 upon receipt and/or stored in Storage 604 accessible to the Computer System 600.

Storage 604 may be accessed by the Computer System 600 with a Storage Interface 606. The Computer System 600 may use the Storage Interface 606 to communicate with the Storage 604. The Storage Interface 606 may include a bus coupled to the storage and able to transmit and receive signals. Storage 604 may include random access memory (RAM) or other dynamic storage devices, for storing dynamic data and instructions executed by the Processor 608. Any number of Processor(s) 608 may be used to execute instructions for the Computer System 600. Storage may include, but is not limited to, read only memory (ROM), magnetic disks, flash drives, usb drives, and optical disks. In one or more embodiments, a Computer System 600 may be connected to a Display 610 for displaying information to a user.

“Computer usable medium” or “Computer-readable medium” refers to any medium that provides information or may be used by a Processor 608. Medium may include volatile and non-volatile storage mediums.

Various embodiments of the present invention may be implemented with the aid of computer-implemented processes or methods (e.g., programs or routines) that may be rendered in any computer language including, without limitation, C#, C/C++, Fortran, COBOL, PASCAL, Ruby, Python, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

In view of the above, it should be appreciated that some portions of this detailed description are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network.

What is claimed:

1. A system for network virtualization in a publish and subscribe middleware architecture, comprising:
a virtual application executing within an execution module on a computer system, wherein the virtual application has a virtual address and the computer system has a logical address;
a network virtualization module for managing message routing for the virtual application;
a data forwarding plane for performing message routing for the virtual application; and
a communication interface for identifying a correspondence between the virtual address and the logical address during message routing with the data forwarding plane and the virtual application.

2. The system of claim 1, wherein the forwarding plane routes messages to the virtual application based upon the virtual address.

3. The system of claim 1, wherein the communication interface performs a translation between the virtual address and the logical address.

4. The system of claim 1, wherein the correspondence between the virtual address and the logical address is determined by performing a lookup to identify a mapping between the virtual address and the logical address.

5. The system of claim 4, wherein the virtual address is determined by performing a mapping of the computer system IP address to the subscription.

6. A method implemented using a processor and a memory for network virtualization in a publish and subscribe middleware architecture, comprising:
executing a virtual application stored in memory on a computer system using the processor, wherein the virtual application has a virtual address and the computer system has a logical address;
managing message routing for the virtual application using the processor;
performing message routing for the virtual application using a data forwarding plane; and
identifying a correspondence between the virtual address and the logical address during message routing with the data forwarding plane and the virtual application using the processor.

7. A computer program product stored in a computer-readable storage medium which, when executed by a processing arrangement, is configured to provide network virtualization in a publish and subscribe middleware architecture, comprising:
a computer program including:
computer readable program code used to execute a virtual application on a computer system, wherein the virtual application has a virtual address and the computer system has a logical address;
computer readable program code used to manage message routing for the virtual application;
computer readable program code used to perform message routing for the virtual application using a data forwarding plane; and
computer readable program code used to identify a correspondence between the virtual address and the logical address during message routing with the data forwarding plane and the virtual application.
